(19) United States
(12) Patent Application Publication
(10) Pub. No.: US 2003/0074564 A1
(43) Pub. Date: Apr. 17, 2003

(54) Encryption system for allowing immediate universal access to medical records while maintaining complete patient control over privacy

(76) Inventor: Robert L. Peterson, Honolulu, HI (US)

Correspondence Address: James C. Wray, Suite 300, 1493 Chain Bridge Road, McLean, VA, 22101, US

(21) Appl. No.: 09/973,796

(22) Filed: Oct. 11, 2001

(51) Int. Cl. H04L 9/00

(52) U.S. Cl. 713/182; 705/51

(57) ABSTRACT

Personal medical information records are made available to an individual without jeopardizing privacy. Medical records are portable and accessible throughout the world via the web. A “key” known only to the patient allows access only to the individual and those chosen by the individual for authorized use. Information is secure, and stored in encrypted format. There is no linkage at the server level between patient identifying data and the medical information except for access by them. The system allows real-time altering and updating of information using a personal identifier plus a password selected by the individual. The identifier may be printed on a card or otherwise carried on the individual's person. The individual chooses a second unique identifier for use when the card is not available. Entering either identifier provides immediate access to the records. No password is needed for viewing of the records, thereby facilitating access in the event of an emergency.

### BACKGROUND OF THE INVENTION

Optimal patient care involves a process of information gathering about the patient and their illness. Much of this data gathering involves gathering of patient medical history about medical conditions and treatments from their past. This activity currently involves a prolonged series of questions, with subsequent elaboration and clarification. Every new provider or medical care situation repeats this process. Since the historical events do not change, this process is redundant, and therefore is an inefficient use of time of both patient and medical personnel. Furthermore, the process is prone to inaccuracies, because of incomplete or faulty patient memory. In emergency situations, the patient may be unable to communicate at all, or there may not be sufficient time to gather all of the necessary information. Clearly, a system of providing universal storage and access to this medical history information would be beneficial, and much work has been done in this regard.

A central repository of medical data, accessible via the Internet, would accomplish the goal of universal accessibility to anyone with Internet access. Unfortunately, the trade-off is a risk that confidential medical information could be made public, thereby compromising the patient's right to privacy. Particular concern has been raised about the ease with which this data could be linked to other databases, to build a profile of the patient that could be potentially damaging. Electronically available information could be sold or stolen, and hackers have proven themselves remarkably resourceful at breaking through even the most secure firewalls. If the data could be linked to the individual user, this could lead to embarrassment, potential discrimination, identity theft, or other problems.

Security schemes have been devised, but the unpredictable nature of medical emergencies means that the “need to know” for essential medical information could be anytime of day or night, and anywhere in the world. With the increase in international travel and advancing age of tourists, it is increasingly likely that emergency situations will arise overseas. Furthermore, emergency medical staffs are quite busy, and will not use any system that causes delays in patient care, ties up medical staff, or require any significant training. The system, in order to be functional, must be very easy to use, provide immediate access to patient data, and require minimal or no special equipment, training, time, or personnel. Thus, conventional protective security measures (password protection, IP address restriction, need for special equipment, need for registration of facilities, etc.) would be unlikely to be adopted by medical personnel, thereby limiting the availability of the medical information, with potentially disastrous consequences. Assuring this level of accessibility while protecting the privacy of patient information has proven to be a vexing problem, and no satisfactory solution can be found in the prior art.

Much of conventional medical information system privacy has been concerned with hospital system and insurance/reimbursement systems. This usually involves specific hardware, (such as smart cards), or complex information transfer protocols which need to be set up and agreed to in advance. Examples include Jain, U.S. Pat. Nos. 5,559,888 and 5,579,393. This work would thus be unsuited for the purpose of universal access which is a major goal of the present invention.

Reece et al. describe a system of providing medical information using an identification number and a password, and providing for phone-in release of HIV status. As noted by Rozen, however this system “provides only limited medical information, requires the physical presence of the photo-identification card, and requires the participation of a conscious and at least minimally functional subject capable of remembering his or her PIN number; conditions not always pertaining in emergency medical circumstances”.

The work of Rozen describes a method of managing and controlling access to personal information, including and especially medical data. This system relies on a central repository of personal information, which can be accessed via the Internet. The system relies on a fixed identifier number (the SSN) and a set of PIN numbers and a password. Viewing access to the data requires either the PIN or a cumbersome and time-consuming process wherein the treating facility contacts a central database administrator. Verification that the requesting facility is an authorized facility pose major problems with both accessibility and privacy, however. If the system requires strict authentication, this will necessarily make it a more time-consuming process, and may capriciously leave out many legitimate medical facilities, such as overseas medical clinics. In addition, the time-consuming nature of this validation would be potentially disastrous in emergencies where every minute counts. On the other hand, if the validation is not stringent, then unscrupulous people could pose as medical facilities to obtain medical information. Since the fixed ID number is meant to be the SSN, this would make it relatively easy to target individuals for privacy attacks.

Rozen specifically teaches the use of SSN as the unique identifier. It is not obvious from this work that this would present a very significant privacy risk. In addition to the risk noted above, wherein privacy could be violated by medical impersonators, privacy could also be violated by unauthorized access from legitimate medical facilities, or by hackers. If the database were stolen or sold, since the data would be directly linked to SSN, it could be indexed, searched, and linked to other databases. This would allow search for the medical records of any individual, and sale of the entire indexed database. Rozen provides no protection against this privacy problem. The work of Ho et al further elaborates the difficultly of assuring privacy. In addition to attacks from hackers or other unauthorized external users, there are privacy risks from within the system. Thus, a privacy system need assure that even the system administrator does not have the ability to locate and view the records of any individual.

The work of Ho attempts to address the problem of a malicious system administrator. Their solution provides for an intermediary database, which links the medical information database to the requesting doctor, and gives a sophisticated system for authentication of user access privileges. This system requires pre-registration on the part of the physicians, and assignment of access privileges. Although this is practical in a closed system like a hospital, it is unsuited to our application due to the need for broader access to the information, and in particular to the desire for immediate emergency access by any medical practitioner.

### SUMMARY OF THE INVENTION

The present invention provides immediate availability of personal medical information records. Privacy, availability and portability are key features of the invention.

The individual's medical records are portable because they are effectively carried with the individual throughout the world. Access is provided anywhere through the worldwide web. Privacy is assured because no one can access the records without a “key” or unique identifier, which are known only to the patient, and are not discoverable with knowledge of patient's name, social security number, telephone number or other nationally indexed information. The information is secure, and is stored in encrypted format. There is no linkage at the server level between patient identifying data and the medical information.

Altering and updating the information requires use of a personal identifier plus a password, which is selected by the individual. The individual, who understands that the information may be made public through theft or other unauthorized use, views all information prior to storage and purges any information that could be used to uniquely identify the individual, or cause him embarrassment if publicly disclosed.

An individual is assigned an identifier, which may be printed on a card, or otherwise carried on the individual's person. The individual chooses a second, memorable, unique identifier for use when the card is not available. Entering either identifier provides immediate access to the records. No password is needed for viewing of the records, thereby facilitating access in the event of an emergency. If the individual is unable to communicate, others may enter the identifier from the card carried by the individual. The individual may change either identifier or password at any time, thereby locking out future access to the data using these identifiers.

The invention makes use of the global availability of information deliverable via the Internet. The medical data is housed in a database which is accessible via the Internet without the need for any other special equipment. In normal use, the encryption scheme is invisible to the end user, but provides powerful protection against unauthorized viewing of the medical data.

A preferred embodiment includes, but is not limited to:

1. Through a universally available (world-wide-web browser) interface, the patient requests a “global key” and is assigned a random alphanumeric string. This string can be entered using any standard keyboard in any country that has access to the world wide web, and can be thought of as their “record number”.

2. The patient then selects a “personal encryption key” and password. This key and password can be arbitrarily complex, and can use any native language character set or encoding as desired by the patient.

3. Medical data is then entered into the record, provided that the user has a key (either global or personal) and password. Editing, deleting, and adding data require password entry. All data is entered by selecting appropriate entries from a list. The lists can be expanded and nested to provide arbitrarily fine details of medical information. The patient can select the degree of specificity that they wish. The medical records are linked to the person only by direct confirmation from the patient that this is indeed his/her medical information. Public viewing of a medical record would therefore be useless, because the person would be anonymous. Use of menu-driven selection also greatly facilitates the task of translation of the medical information, allowing the information to be viewed globally in a variety of appropriate languages. It also facilitates the process of data gathering and standardization across these various languages.

4. The medical data is encrypted using a two key encryption technique. The first key is the patient's unique personal encryption key. The second is a unique key generated at the server side at the time of encryption. This can be unique for each record, can be arbitrarily complex, and can include characters that cannot be generated by standard keyboard entry or displayed using standard displays.

5. In order to retrieve a record, the user sends a request, using either the “global key/record number” or the unique “personal encryption key”. This request is sent via a worldwide web browser interface or other. The server interprets the demand for the record, and accesses lookup tables (which are not publicly accessible) to retrieve the record number, personal encryption key, and server side encryption key. Using this information, the record is retrieved, decrypted in a two-step process using the server side key and the personal encryption key, and returned in unencrypted fashion to the requesting browser.

6. To modify a record, a password in addition to the “global key/record number” or the unique “personal encryption key” must be supplied. Using this password, the user can modify any data, including the password, the “global key/record number” or the unique “personal encryption key”. The user has complete control over the entire record, but may relinquish edit control to a trusted source (family member, physician, etc.) by revealing their password. Any information the patient wishes to keep at a higher level of privacy can be stored in a password protected mode, unavailable to the access scheme presented in number 5 above. This would, of course, limit access by medical care providers as well.

Summary of Security Features

The main areas of concern regarding privacy of medical records center around three main problems, among others:

1. Embarrassment at the revelation of private medical information. This is well protected as detailed above. In addition to the encryption and anonymity features, the patient has complete control. The patient can weigh the potential medical advantages of revealing information that could be potentially embarrassing or compromising against the risk of embarrassment in the event that all of the security features fail. This risk/benefit analysis can be weighed in the context of other potential privacy leaks such as doctors' offices, hospital clerks, pharmacy technicians, etc.

2. Discrimination because of adverse medical information by insurers, employers, etc. Our system is seen to provide excellent protection here, because the employer, insurer, etc. would not be able to determine with an acceptable degree of certainty which member corresponds to which record. Because of this, there would be no market for resale of the database to insurers and employers, and therefore less temptation for this sort of profit-driven invasion of privacy. Furthermore, the transmission of the patient's medical information, which is easy with the patient's consent, would be next to impossible without it (it would lack the necessary decryption key and demographic information).

3. Concerns about identity theft: Again, this system is seen to provide a good degree of protection against identity theft, since there is no linkage between the medical data and the financial or demographic data that identity thieves are seeking. In addition, the ability to immediately change the access keys can “lock out” any identity thieves once the theft (e.g. of a purse or wallet) is known. Identity theft by electronic “hacking” of the database would be extra-ordinarily difficult and fruitless, for the reasons cited above.

Differences from Conventional Privacy Schemes

The advantages include, but are not limited to:

1. All data is anonymous. No data are collected which would unambiguously identify the patient, unless they choose to do so.

2. No password is required to view the data. This important usability difference allows medical personnel access to the data in an urgent care situation, using only the personal encryption key or the global key. If a password were used for viewing the data, then a second password would be required for edit control, making the system harder to use. If the same password were used for viewing and editing, this would reduce the degree of control that the patient has over the data, and make it more difficult for them to protect their record.

3. There are two access keys, either of which will allow view access of the data. This is a major difference from systems that merely assign a “user ID number”. The need for global access dictates a need for two keys as described below:

a. The personal encryption key must be easy for the patient to remember, yet complex enough to be difficult to guess. For non-English speaking patients, this means choosing a native language-based key, which would have non-Western characters. These characters are impossible to enter on a standard keyboard without a special input method, thus necessitating a separate alphanumeric key for access when traveling in other countries.

b. The alphanumeric key needs to be sufficiently long to accommodate a large number of users, and their ability to change the number at will. Thus, the number is very difficult to remember. If this were the only way to access the record, access would be impossible in the absence of a card or other form of written memory.

4. All medical data is based on look-up tables that are specifically designed to provide medical information without revealing specific details about the patient. This helps to preserve anonymity. No demographic data, for example, is needed, since there would be no need to access the information without the presence or explicit consent of the patient, who could easily provide all other identifying data. Thus, there can be no possibility of “third party” exchange of medical data without the patient's consent.

5. The global nature of the system is enhanced by the use of a menu-driven system for data input. This simplifies the tasks of translation, standardizes the data, and makes data entry easier for those who cannot type.

This system can be used for data other than medical information (e.g. financial records, etc.) but seems ideally suited to the medical situation. The patient who is in need of medical services will always be physically present, and thus able to corroborate the data (verbally or by physical examination) and provide any additional non-medical information as desired.

This invention allows for many benefits to the user. The service presented by this invention is free for the patients, so no one can be denied care on the basis of cost. This service is also free for doctors, so they can rapidly access the information without hesitation or delay.

The process presented here is fast, medical summaries are available to the doctor within a few seconds. Time is not wasted in looking through thick charts and the doctors get the information they need, in the format they want, right away. The patient does not have to fill out the same information over and over. The patient fills it out once here, and then updates it as conditions change.

Privacy is achieved by this invention. The medical summaries can also be accessed from any Internet terminal in the world at any time of day in many languages. Entering the correct data is easy and quick, and controlled completely by the user. The user decides what to put in and what to keep out.

These and further and other objects and features of the invention are apparent in the disclosure, which includes the above and ongoing written specification, with the claims and the drawings.

### BRIEF DESCRIPTION OF THE DRAWINGS

FIG. 1 is a schematic diagram showing data relationships between the users table, the security table, and the personal data table.

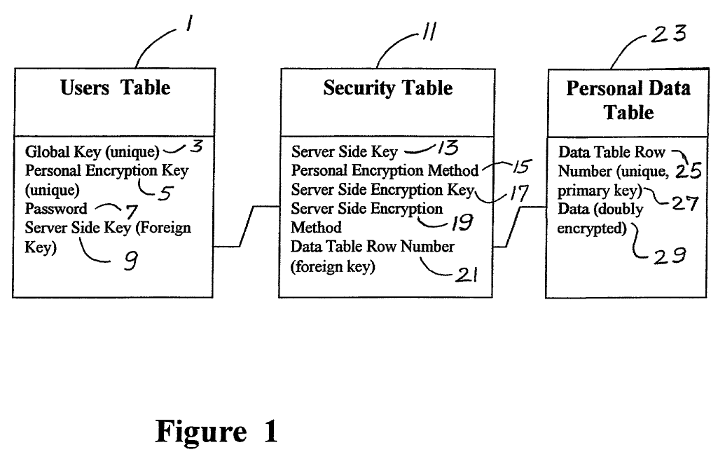

FIG. 2 is a schematic diagram of the user/patient registration process.

FIG. 3 is a schematic diagram of the process of data retrieval from the server side data.

FIG. 4 is a schematic diagram that shows the process of data modification.

FIG. 5 is a schematic diagram that shows the process for change of user access parameters.

### DETAILED DESCRIPTION OF THE PREFERRED EMBODIMENTS

The preferred embodiment comprises a system for immediate access of personal data using the Internet and the World Wide Web. Emergency medical treatment provides a good illustration of the advantages of the current invention.

In anticipation of possible need for emergency treatment, the patient registers at the website that provides for the information storage. At this time, the service provider sets up a new record in the User Table 1, and assigns unique Global Key 3 (GK), SSID values, and prompts the patient to enter a unique Personal Encryption Key 5 (PEK) and password 7. Records are retrieved and decrypted in a two-step process using the server side key 9 and the personal encryption key 5, and then returned in unencrypted fashion to the requesting browser.

The intermediary Security table 11 links the location of data 29, which is double encrypted, in the Data Table 23 to the appropriate entries in the User Table 1, which is not accessible online. The security table comprises server side key 13, personal encryption method 15, server side encryption key 17, server side encryption method 19, and data table row number 21. Each of these elements ensures the users security in accessing the data 29 from the data table 23. The personal data table comprises data table row 25, a unique, primary key number 27, and finally double encrypted data 29.

The users table 1 and the security table 11 are related through SSID, generally server side key 9, 13. The security table 11 and the personal data table 23 are related through data table row number 21, 25.

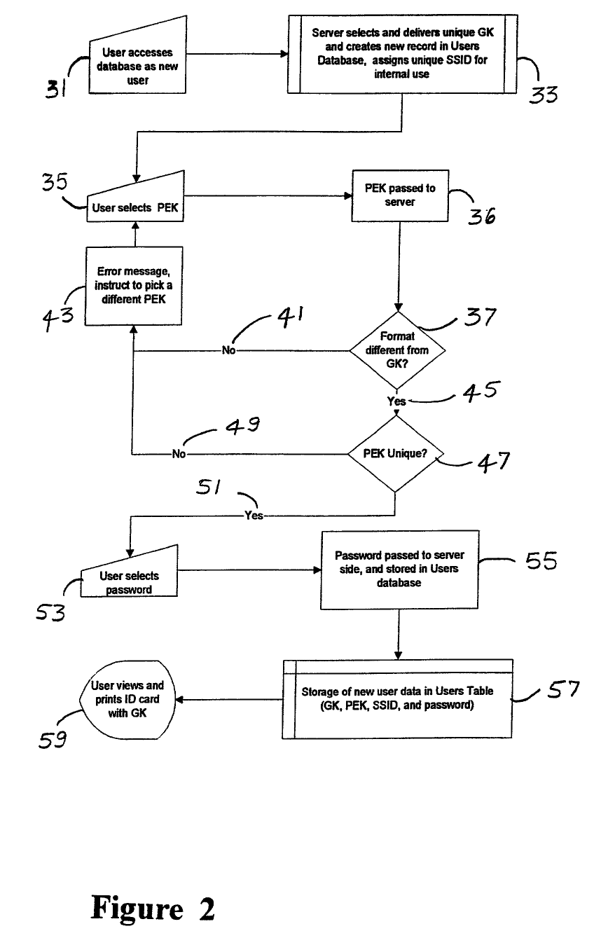

Referring to FIG. 2, the patient registers at the website that provides for the information storage. The user accesses the database as a new user 31. At this time, the service provider sets up a new record in the User Table, and assigns unique Global Key (GK) and SSID values 33. The user is then prompted to select a PEK 35. The entered PEK is then passed 36 to the server 37. The server then determines if the format is different from the GK. If the answer is yes 45, the PEK is then analyzed 47. If the answer is no 41, the user is sent an error message and instructed to pick a different PEK 43 and returns to selecting a PEK 35. The PEK is analyzed for uniqueness 47. If the PEK is unique 51, the user then is prompted to select a password 53. If the PEK is not unique 49, the user is delivered an error message 43 and is instructed to pick a different PEK. After the user selects a password 53, the password is passed to the server side and stored in User's database 55. New user data, such as, yet not limited to, GK, PEK, SSID and password, are stored in User's Table 57. The user, after proper registration, may view and print an ID card with GK 59.

Typically, the GK will be a long alphanumeric string, which is difficult to remember, and which can be entered on any standard computer keyboard in the world. The patient is instructed to print out or otherwise record the GK, and to print out an identification card to be carried in a wallet or purse. The card contains instructions for emergency personnel, to access the website to find the medical information. Alternatively, the patient may choose to carry this number on an identification bracelet or in other form. The PEK is intended to be easy to remember, and can be a word, phrase, or other in the patient's native language and character set. The SSID is intended for internal use only. It thus does not have to be memorable, and in fact may not even be displayable on standard monitors.

Referring to figure three, the schematic diagram shows the process of retrieving and viewing data. The user enters user's ID string 71. The user ID is sent to the server 73 and through a firewall 75 before it is analyzed. The server then determines whether the entered ID string matches any GK or PEK in the user database 77. If the answer is no 81, the user is sent an error message 83, “incorrect ID” for example, and prompted for entry of a different ID string. If the answer is yes 79, the server retrieves corresponding records form the user database 85, including, for example, SSID, GK, and PEK 85. The server then retrieves the PEK method, SSEK and SSEK method, and data table row number for all records in the security table that match the specified SSID 87.

The server then retrieves all records from the medical data corresponding to the security table entries 89. The records are then decrypted 91 using the corresponding PEK and PE method. Next, the records are decrypted 93, for a second time, using the corresponding SSEK and SS method. The doubly decrypted records are formatted and sent to the client 95. The client can then view the data 97. The client can also add or edit the data 99.

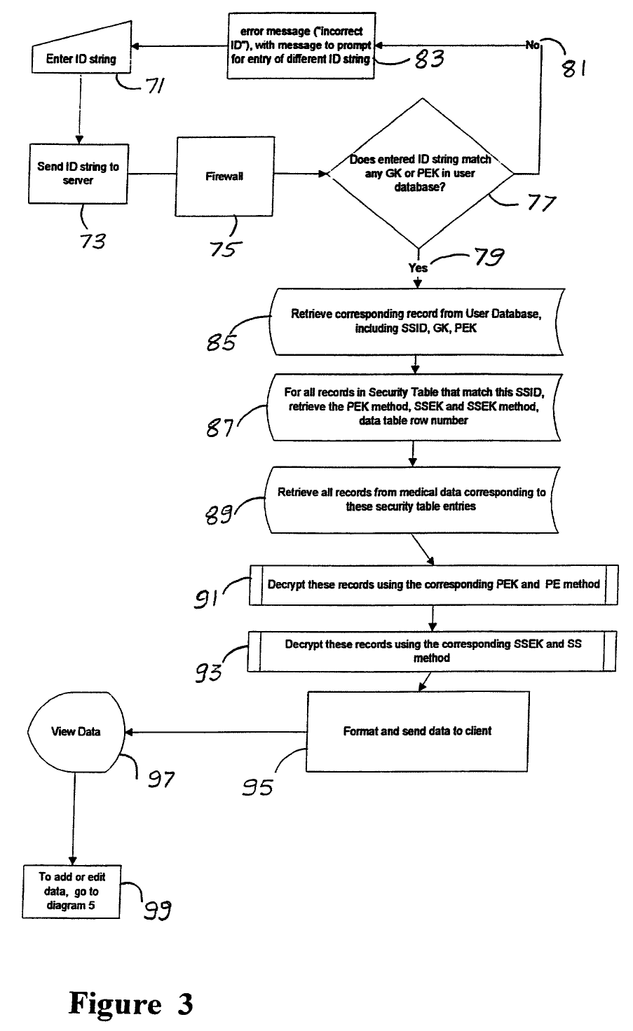

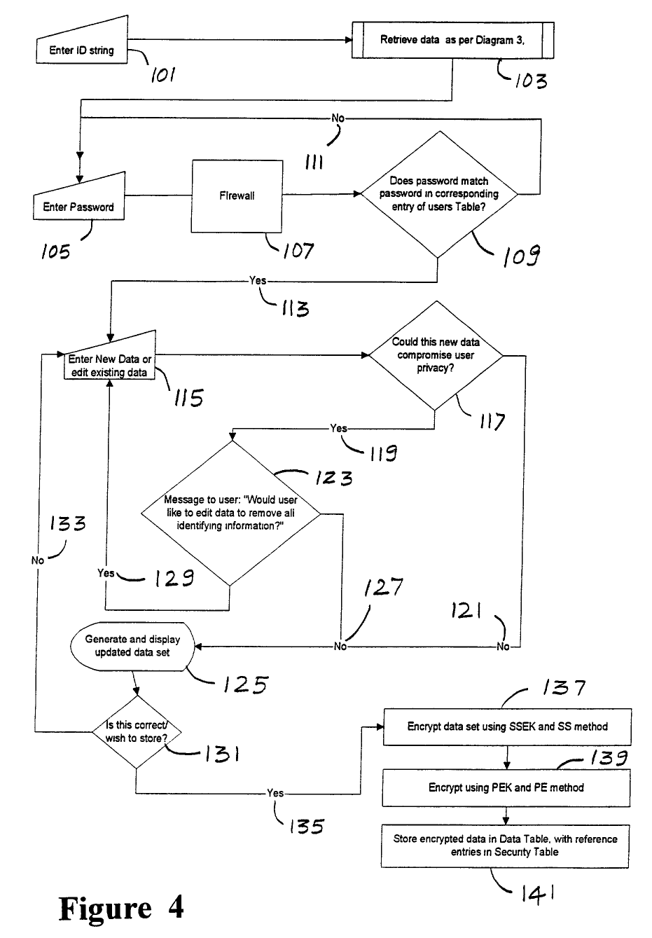

Referring to FIG. 4, the schematic diagram shows how the user adds or edits data. The user must enter an ID string 101 and retrieve the data 103, as shown in FIG. 3. The user must then enter a password 105, which is sent through a firewall 107 and then analyzed 109 to see if the password matches the password in the corresponding entry of the users table. If the password does not match 111, the user is prompted to enter another password 105. If the password does match 113, the user may enter new data or edit existing data 115. After this process, the user is asked whether this new or edited data could compromise the user's privacy 117. If yes 119, the user is then asked if user would like to edit data to remove all identifying information 123. If no 121, the server generates and displays the updated data set 125. If the user does not wish to edit the data 127, then the data is generated and displayed as a data set 125. If the user wishes to edit the data to remove all the identifying information 129, then the user returns to edit the existing data 115. The user is asked, from here, again whether the new data or edited data could compromise the user's privacy 117. If the answer is no 121, the data is generated and displayed as an updated data set 125. Next the user is asked whether the updated information is correct 131, and if so does user wish to store the information? If the data is correct, user selects yes 135, if the updated data is incorrect, the user selects no 133 and returns to edit the data or enter new data 115.

If the data is correct, the user wishes to store the data, and thus selects yes 135, the data is encrypted 137 using the SSEK and SS method. The data is then encrypted for a second time 139 using the PEK and PE method. The encrypted data is then stored 141 in the data table with reference entries in the security table.

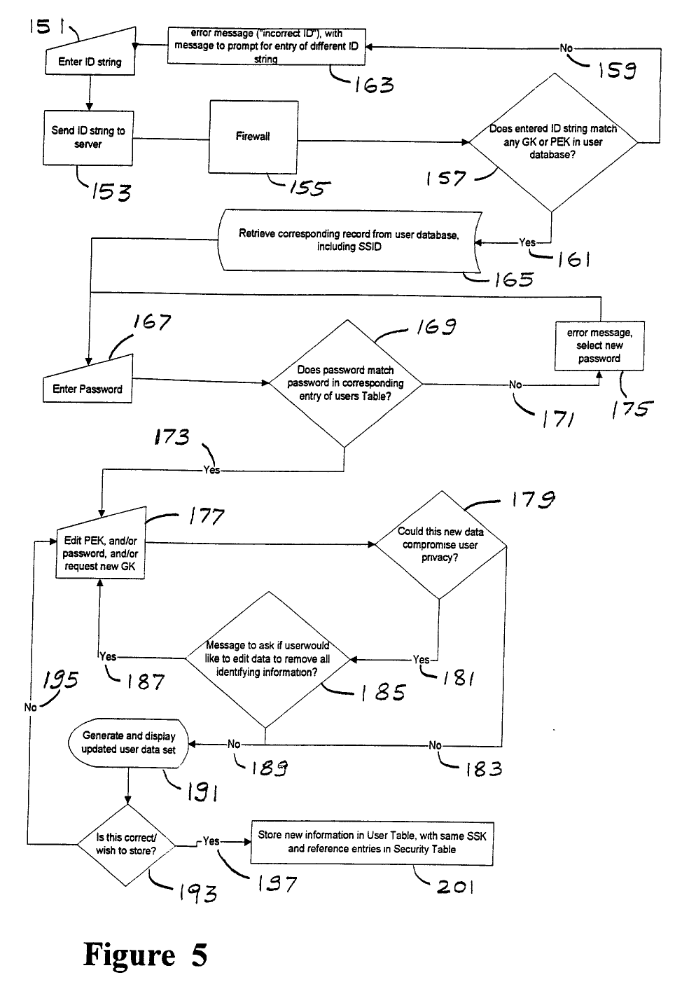

Referring to FIG. 5, the schematic diagram shows how user access parameters are modified. The user first enters an ID string 151. The ID string is sent to the server 153, through a firewall 155, and then analyzed 157. The server determines whether the ID string entered matches any GK or PEK in the user database. If no 159, the user is prompted with an error message 163 and must enter a different ID string 151. If yes 161, the server retrieves corresponding records from the user database, including SSID 165. The user then enters a password 167, which is also analyzed 169. If the password matches a password in a corresponding entry in the user's table 173, the user proceeds to edit 177 PEK, password or GK. If the password does not match 171, then the user is sent an error message 175 and prompted to enter a new password. Once an acceptable password is entered and verified, the user may edit 177 the PEK, password or GK. After editing, the user is asked whether the new or changed data could compromise the user's privacy 179. If the answer is yes 181, the user is prompted with a message 185 and asked if the user would like to edit the data to remove all the identifying information. If yes, 187, the user returns to editing 177. If no 189, the information is generated and displayed as updated in the user data set 191. When asked if the new data could compromise user privacy 179, if the user answers no 183, the updated data is automatically generated and displayed as the user data set 191.

After the data is updated and viewed by the user, the user is prompted to determine whether the corrections or new information is correct or if the user wishes to store the information 193. If the user answers no 195, the user then returns to edit 177 the PEK, password or GK. If the user answers yes 197, the new information is stored 201 in the user table, with the same SSK and reference entries in the security table.

Having registered, the patient then proceeds to enter pertinent medical data. This data can be entered real-time via on-line forms, fax, e-mail, scanned data, direct electronic feed from medical equipment, etc. Once the information is gathered, the patient is instructed to check the data and purge any information that would identify him/her, or that would otherwise cause them a privacy concern if made public. If so, they are offered the chance to edit the data real-time from anywhere to their satisfaction, or to accept the trade-off of potential privacy violation and access to this information. This is an important step for privacy, because it is assumed that information of value (such as medical records) will be sold or stolen eventually, despite the best intentions of the system designers. Data can be modified at any time, provided that the patient provides an identification key (PEK or GK) and a password.

To protect the patient's privacy, the information is then encrypted in a two-step encryption process. The first step uses the patient-selected PEK as the encryption key. This key will therefore be of variable length, and can involve characters from all of the world's languages. In addition, the patient can change this key as often as desired. A second step of encryption uses a key generated on the server side, and unknown to the patient. This key can be arbitrarily complex, since it is used on the server side only. The methods of encryption can be varied as well, from record to record. The encrypted medical information is stored in a database which is not directly accessible online, and which does not contain any of the fields from the User Table. The intermediary Security table links the location of data in the Data Table to the appropriate entries in the User Table, which is also not accessible online.

There could be several levels of information, each with its own password. Any information that the patient wishes to keep at a higher level of privacy could be stored in a password protected mode, unavailable for viewing without this password. This would, of course, limit access by medical care providers as well.

At the time of visit to a medical facility, the patient would normally be expected to present the card, which contains their GK and the web site URL of the medical storage service provider. Medical personnel then enter this GK. If the GK valid, then the patients medical information is retrieved, decrypted, and presented. If the GK is invalid, a message to this effect is passed back to the medical facility, and they are instructed to try again, or to check the number with the patient. Server side monitoring prohibits access to anyone who submits a suspiciously large number of GK or PEK in a given period of time (“hackers”) until cleared by the system administrator.

Accessibility: Universal Access

There are two possible keys and one password, giving a total of 8 possible conditions for attempted access to medical records. These are detailed below. In summary: access for viewing only of the records is provided in the three cases where either or both of the keys are available, but the password is not. In the three cases where either or both keys are available and the password is available, then full view/add/edit/delete access is granted. If neither key is available, access is denied, whether the password is available or not. Fuller descriptions of this are provided in the case descriptions below exemplifying preferred features.

TABLE 1
Use case scenarios

| Global Key | Personal Key | Password | Resulting | |
|---|---|---|---|---|
| Available? | Available? | Available? | Action | Description |
| No | No | No | Access denied | Case 0 |
| Yes | No | No | View Only | Case 1 |
| No | Yes | No | View Only | Case 2 |
| Yes | Yes | No | View Only | Case 3 |
| No | No | Yes | Access Denied | Case 4 |
| Yes | No | Yes | View and Edit | Case 5 |
| No | Yes | Yes | View and Edit | Case 6 |
| Yes | Yes | Yes | View and Edit | Case 7 |

Case 0: No key or password available, or they are incorrect. This would be the situation if the patient has forgotten their personal key and does not have access to their global key. This then reverts to the current “state of the art” and makes is equivalent to the situation for those patients whose data is not yet stored in the data repository. For privacy reasons, no other means of access to the data is provided. See below.

Case 1: Patient or authorized user seeking medical information summary, and has global key available (“Medic alert bracelet”, or printed card, etc.). Personal encryption key not available (patient has forgotten it or does not wish to reveal it).

1(a): If the patient can communicate, then he/she can present the global key to the medical personnel, authorizing access to the medical information. The medical personnel then access the web site, and as in step 5 above, the record is accessed, the global key is used to find the personal access key in the off-line look-up table and used to decrypt the record, which is then passed back to the medical personnel. The patient can then affirm that the record is correct, and receive appropriate treatment. Since the global key is a long alphanumeric string, it is very unlikely that the medical personnel would remember it. This will decrease the likelihood of “sharing” of this access code among medical personnel or of “after hours” access. In addition, the patient may use their password-restricted access to change this number at any time, thereby restricting any future unauthorized access.

1(b): If the patient cannot communicate (e.g. unconscious) due to medical conditions or other reasons, the medical personnel may find the global key while searching for identifying information about the patient. (e.g. on a card in a wallet, or medic alert bracelet). In this case, the urgent nature of the situation will give the medical personnel tacit approval to access the website and medical record. The medical personnel will obtain medical data which may be useful, but will still have to assure that the data matches the patient. (The data could be out of date, or the card could belong to someone else, for example).

Case 2: patient seeking medical attention, and has personal encryption key available. If the patient can communicate, they can authorize access to their medical data in one of two ways:

2(a): The patient can present their personal encryption key directly to the medical providers, authorizing access to the medical information. The medical personnel then access the web site, and as in step above, the record is accessed, decrypted, and passed back to the medical personnel. The patient can then affirm that the record is correct, and receive appropriate treatment. Since the personal encryption key is more likely to be “memorable”, the patient may prefer 2(b) below, or may wish to change their key as soon as possible after the data is retrieved.

2(b): The patient (or a friend, family member, etc.) can use the internet to access their record and retrieve the global key. This global key can then be given to the medical personnel, who access the medical data as in 1a. above. Since the global key is a long alphanumeric string, it is very unlikely that the medical personnel would remember it. This will decrease the likelihood of “sharing” of this access code among medical personnel or of “after hours” access. In addition, if the patient has selected a personal key that contains special characters (e.g. Chinese, Japanese, and Arabic words, etc.) then these special characters may not be able to be entered at the point of medical treatment. In this case, the user can contact someone (family, friend, interpreter, etc.) who can key in their personal code and retrieve the global code. Again, to protect privacy, the patient can change their key codes immediately after the medical encounter. This illustrates the need for a global key in addition to the personal key for use in a global system.

Case 3: Both global key and personal encryption key available: In this case the patient can select the key of their preference, and it reverts to a choice between case 1 and case 2 above.

Case 4: Neither access key available. In this case access is denied, even if the password is available. Denial is absolute, because the record cannot be decrypted without knowing the personal encryption key.

Case 5: Global access key is available, as well as password. In this case the user would be able to view the record, and add or change any data in the record, including the global key, personal encryption key, or password. After accessing the record as described in cases 1-3 above, the user would be prompted for a password if “edit” is selected. The password is sent to the server, where it is compared with the appropriate password in the off-line look-up table. If the passwords match, then editorial access is granted. If not, then it is denied, and the situation reverts to case 1, 2, or 3 above.

Case 6: Personal access key is available, as well as password. In this case the user would be able to view the record, and add or change any data in the record, including the global key, personal encryption key, or password. After accessing the record as described in cases 1-3 above, the user would be prompted for a password if “edit” is selected. The password is sent to the server, where it is compared with the appropriate password in the off-line look-up table. If the passwords match, then editorial access is granted. If not, then it is denied, and the situation reverts to case 1,2, or 3 above.

Case 7: Global access key and personal access key available, as well as password. In this case the user would be able to view the record, and add or change any data in the record, including the global key, personal encryption key, or password. After accessing the record as described in cases 1-3 above, the user would be prompted for a password if “edit” is selected. The password is sent to the server, where it is compared with the appropriate password in the off-line look-up table. If the passwords match, then editorial access is granted. If not, then it is denied, and the situation reverts to case 1,2, or 3 above.

Privacy: (Prevention of “Unauthorized Access”)

The above cases demonstrate how the system provides universal access provided that either key is available. This section describes how privacy is protected.

1. Attempts to access the database without a valid global key or personal access key will be rejected. Since the global key is a 16 digit number, it would be difficult to “guess” a valid key, and “lockout after three invalid tries”, etc. can be used to discourage hackers. Similarly, although it might be possible to guess a valid personal encryption key, the anonymous nature of the data would make it uninteresting. The difficulty of guessing the personal encryption key will depend on its complexity, and thus the patient can balance ease of use (easier to remember) against potential invasion of privacy, and make the key arbitrarily long. The patient also has the usual options of changing the keys at will to increase privacy.

2. The records are encrypted using a two key encryption scheme. Thus, unencryption requires both keys. Illicit access to the entire database would require very laborious record by record unencoding.

3. A key privacy feature is assured by maintaining strict anonymity in the recording of medical information. This will provide privacy even if levels one and two are breached. Note that there is very little tradeoff in usability by maintaining anonymity, since the presence of the patient will provide confirmation that the data is in fact theirs, and provide easy access to other identifying data such as name, date of birth, social security number, etc.—information which is not essential for medical care but which would severely compromise privacy. Note that anonymity also provides for “plausible deniability” since there are likely to be many people with similar medical summaries, as delineated in #4 below.

4. Additional security can be maintained by encoding all medical information as pointers to look up tables. In addition to removing any information which is specific enough to uniquely identify the patient, this will make it difficult for unauthorized users to determine whether their illicit decryption scheme is accurate, since virtually any string will generate a seemingly valid medical record.

5. If there is a risk that the patient may be linked by name to a record, (e.g. lost wallet), the patient can immediately change the access keys to lock out any unauthorized viewing of their information. This can also be done after each authorized viewing of the data, to lock out “after hours” viewing of the medical data. The unauthorized user cannot edit the data or the records, of course, without access to the password.

6. Further privacy is assured by giving the patient complete control and edit access to the record. Thus, the patient can determine which data they wish to include in their record, and which they do not. They can individually weigh the benefits of availability of the medical information against the risk of public disclosure in the event that the above security measures fail. Several levels of access can be provided, each with its own password, to control access to subsets of medical information.

While the invention has been described with reference to specific embodiments, modifications and variations of the invention may be constructed without departing from the scope of the invention, which is defined in the following claims.

I claim:

1. A method of securing privacy while allowing immediate, universal real-time access to personal information comprising providing a server for storing user related personal information, providing real-time access to the server, enabling the user to input, edit, and to access stored information from anywhere, providing a user database for storing and retrieving user-encrypted unique identifier codes input by the user, linking the user related information with the user database, providing stored information after verification of the user's unique identifier codes, allowing the user to access, edit, input, view and retrieve personal information from any location as desired.

2. The method of claim 1, wherein providing the user database comprises prompting a user to input a personal encryption code.

3. The method of claim 2, further comprising prompting the user to input a password.

4. The method of claim 3, further comprising assigning to the user a unique alphanumeric ID number.

5. The method of claim 4, further comprising assigning a unique server side identifier number for internal, server side use.

6. The method of claim 5, further comprising storing the encryption code, password, alphanumeric ID number and the identifier number in the user database.

7. The method of claim 1, further comprising prompting the user to input data that is to be stored on the server for accessing on-line.

8. The method of claim 7, further comprising allowing the user to edit the input data to purge anything embarrassing and to remove anything identifying the user if made public.

9. The method of claim 8, further comprising encrypting data using a user-selected ID as the encryption key, and associating an encryption method corresponding to the encryption key.

10. The method of claim 9, further comprising providing additional encryption using an additional encryption key generated by the server and associating an additional encryption method corresponding to the additional encryption key.

11. The method of claim 10, further comprising storing the initial and the additional encrypted data in a personal data database.

12. The method of claim 11, further comprising creating a security database and linking the records in the encrypted personal datafile to the user only.

13. The method of claim 12, further comprising making a record in the security database corresponding to each record stored in the personal datafile, and storing in the made record the location of the personal data, the associated user identifiers input by the user.

14. The method of claim 13, further comprising allowing access to and disclosing the information in the personal datafile upon presentation of either the user identifier input by the user.

15. The method of 13, further comprising enabling alteration of any of the personal information in the data file upon presentation of the user identifier in conjunction with presentation of the user password.

16. The method of claim 13, further comprising enabling alteration of the user identifiers upon presentation of the user identifier in conjunction with the password.

17. An encrypted medical records global access system comprising, a computer database, an output communicating with the database and the internet for real-time access of the database via the Internet, and data inputs and editing inputs connected to the database and connected to the Internet for inputting and editing data via the Internet from geographically dispersed locations.

18. The system of claim 17, further comprising storing data in the database, wherein the data is stored as binary identifiers and retrievable as original data input by the individual.

19. The method of claim 18, further comprising storing data associated with particular values in all medical records, storing suggestions according to the particular data, comparing the individual's medical records with the data in the server and providing some of the stored suggestions to the individual when providing the individual's medical record.

20. The method of claim 18, further comprising storing data comprising multiple medical records in the server, comparing the individual's medical record with the multiple medical records in the server and providing suggestions to the individual according to the comparing when providing the individual's medical record.

21. The method of claim 17, further comprising inputting unique encrypted identifiers relating to a particular individual in a personal database, inputting medical information data in an information database, exclusively linking the personal database and the related information database, providing access to the data via a global communications network, storing the information in the database, identifying and verifying the individual via the unique encrypted identifiers and interrelating the individual's medical information with the unique encrypted identifiers, and providing global access to the individual for inputting, editing, deleting and transferring data as desired.

22. The method of claim 21, further comprising storing interrelations of the unique encrypted identifiers with the individual's exclusive medical information and providing instant access to the user after verifying the identifiers.

23. A medical records universal access system comprising encoding and decoding user identifiers, storing the identifiers in a database, inputting and storing medical information in the database by a user, exclusively linking particular user identifiers only to the user's stored medical information, allowing the user to globally access the medical information using the user identifiers and allowing the user to edit, change, remove, modify and augment the medical information in real-time.
